(19) United States
(12) Patent Application Publication
(10) Pub. No.: US 2026/0141408 A1
(43) Pub. Date: May 21, 2026

(54) LIGHT-BASED AUTHENTICATION SYSTEMS AND METHODS

(71) Applicant: INTELLIGENT MATERIAL SOLUTIONS, INC., Princeton, NJ (US)

(72) Inventors: Howard Bell, Princeton, NJ (US); Joahua Collins, Wallingford, PA (US); Viva Bell, Princeton, NJ (US)

(73) Assignee: INTELLIGENT MATERIAL SOLUTIONS, INC., Princeton, NJ (US)

(21) Appl. No.: 19/394,161

(22) Filed: Nov. 19, 2025

Related U.S. Application Data
(60) Provisional application No. 63/722,260, filed on Nov. 19, 2024.

(51) Int. Cl. G06Q 30/018

(52) U.S. Cl. CPC G06Q 30/0185

(57) ABSTRACT

The present disclosure provides a system for authenticating a physical item comprising an upconverting phosphor (UCP) layer that emits visible light upon near-infrared excitation, and a covert marking representing an encrypted code derived from UCP emission points. The system includes a mobile device with a near-infrared VCSEL, optical sensor, and processing units. The processing units cause the VCSEL to excite the UCP layer, creating a lightmap, capture images of the covert marking and lightmap, digitize emission point counts within defined sectors to form numerical sequence S′, read and decrypt the encrypted code using a rotor-based algorithm to produce decrypted sequence D, and compare S′ to D to determine authenticity.

### CROSS-REFERENCE TO RELATED APPLICATIONS

This application claims priority to U.S. Provisional Application No. 63/722,260, titled LIGHT-BASED AUTHENTICATION SYSTEMS AND METHODS, filed Nov. 19, 2024, which is hereby incorporated by reference in its entirety.

### TECHNICAL FIELD

The present disclosure relates to techniques for authenticating various physical items, and more particularly to authentication using upconverting phosphor layers, light blocking layers, and pattern recognition techniques.

### BACKGROUND

Authentication of the validity of valuable articles, such as documents, machine parts, luxury goods, and consumer products, has become increasingly challenging in many fields. There is a growing impetus to reduce fraud and prevent counterfeits and forgeries which are often elements of existing fraudulent use of these types of articles. For example, counterfeit checks can be produced by criminals who copy or scan a legitimate check to extract bank data, signature data, and account data and then produce checks which appear identical to genuinely issued documents. Similarly, altered documents may use genuine substrates, but where the payee or the amount is altered, presenting difficulty of detection. Stolen check stock may also be utilized to forge checks where the payee, amount and signature are fraudulently imprinted.

Authentication challenges extend beyond financial documents to include a wide range of consumer goods and industrial products. Counterfeit luxury items, pharmaceutical products, electronic components, and branded merchandise represent significant economic losses and potential safety hazards. Traditional authentication methods often rely on visual inspection of security features, which can be subjective and may not provide adequate protection against sophisticated counterfeiting techniques.

Machine readable authentication and verification methods offer advantages over manual inspection processes. However, many existing systems rely on the secrecy of certain algorithms, the distribution of secret decryption or encryption keys, or access to unique inks or compounds which are used to mark substrates. Such approaches may present vulnerabilities when the security mechanisms become compromised or when the authentication infrastructure becomes unavailable.

Mobile device-based authentication systems have emerged as a potential solution, leveraging the widespread availability of smartphones and tablets equipped with cameras and light sources. These devices can potentially provide convenient, accessible authentication capabilities without requiring specialized equipment. However, developing authentication systems that are both secure and affordable while providing reliable verification remains a technical challenge.

Various optical authentication approaches have been explored, including the use of phosphor materials that can absorb light at one wavelength and emit light at a different wavelength. Such materials can provide covert security features that are not readily apparent under normal viewing conditions but become visible when excited by appropriate light sources. The development of upconverting phosphors, which can convert near-infrared radiation to visible light, has opened new possibilities for authentication applications.

An improved method and system for authentication and verification that addresses these considerations would be beneficial.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a system for authenticating a physical item is provided. The system comprises an upconverting phosphor (UCP) layer disposed on the physical item and configured to emit visible light upon near-infrared excitation. The system comprises a covert marking printed on the physical item representing an encrypted code derived from a pattern of emission points of the UCP layer. The system comprises a mobile device comprising a near-infrared vertical-cavity surface-emitting laser (VCSEL), an optical sensor, and one or more processing units. The one or more processing units are configured to, collectively, cause the VCSEL to emit light to excite the UCP layer, the excitation of the UCP layer emitting light that forms a lightmap. The one or more processing units are configured to capture at least one image of the physical item, where each image includes the covert marking, the lightmap, or both (both the covert marking and the lightmap must be captured by the images). The one or more processing units are configured to digitize counts of the emission points falling within each of a plurality of defined sectors of the image of the lightmap to form a numerical sequence S′. The one or more processing units are configured to read the encrypted code from the covert marking. The one or more processing units are configured to decrypt the encrypted code using a rotor-based algorithm to produce a decrypted sequence D. The one or more processing units are configured to compare numerical sequence S′ to decrypted sequence D to determine authenticity.

According to other aspects of the present disclosure, the system may include one or more of the following features. The rotor-based encryption algorithm may comprise multiple logical rotors having independently variable offsets and a manufacturing seed key. The covert marking may comprise microtext printing, UV-visible ink, IR-absorptive ink, nano-dot patterning, laser micro-engraving, or a combination thereof. Authentication may be confirmed when a difference metric between numerical sequence S′ and decrypted sequence D is within a predefined statistical tolerance. The mobile device may be configured to provide a visible verification indicator or match score on the device display. The UCP layer may contain phosphors having distinct decay-time and/or spectral signatures, and the mobile device may form part of the numerical sequence S′ based on the distinct decay-time and/or spectral signatures. The encryption and decryption algorithms may be implemented within a dedicated mobile application stored on the device. The system may be free of an active network connection. The system may be free of a remote database. The mobile device may be operably coupled to a remote database. The one or more processing units may be further configured to compare a lightmap generated from the at least one image to a lightmap stored on the remote database. The physical item may be a card, banknote, a clothing hangtag, or a product label. The emission points in the UCP layer may consist of a plurality of types of phosphors. The emission points in the UCP layer may consist of a single type of phosphor. The physical item may further comprise a radiation blocking layer disposed as a film or ink. The radiation blocking layer may be operably coupled to at least one side of a base substrate upon which the UCP layer is disposed, the radiation blocking layer configured to absorb near-infrared light that would excite the emission points within the UCP layer. The physical item may further comprise a transparent window through at least a portion of a base substrate upon which the UCP layer is disposed.

According to another aspect of the present disclosure, a method for manufacturing an authenticated item is provided. The method comprises applying an upconverting phosphor layer to a target item. The method comprises exciting the upconverting phosphor layer to generate a lightmap. The method comprises dividing the lightmap into sectors and counting emitting points within each sector to produce a numerical sequence S. The method comprises encrypting S using a rotor-based algorithm to produce an encrypted sequence C. The method comprises incorporating C as a covert marking on the target item at or near the location of the upconverting layer.

According to other aspects of the present disclosure, the method may further comprise verifying the item by using a mobile device to re-excite the UCP layer and form the lightmap, generating a numerical sequence S′ based on the lightmap shown in at least one captured image, reading the covert marking from the at least one captured image, decrypting the covert marking to form decrypted sequence D, and confirming authenticity when decrypted sequence D ≈numerical sequence S′.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 is an illustration of an embodiment of a system

FIGS. 2 and 3 are illustrations of embodiments of lightmaps.

FIGS. 4 and 5 are illustrations of other embodiments of systems.

FIGS. 6A and 6B are illustrations of a process for authenticating an item by considering the front (6A) and back (6B) of a tag containing embodiments of the phosphor and blocking layers.

FIG. 7 is an illustration of a physical item that utilizes the disclosed system.

FIGS. 8A-8D are illustrations of an authentication process showing sector-based analysis and encryption/decryption operations for verifying a physical item using lightmap patterns and covert markings.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

There are several challenges and technical problems that persist in the prior art related to authentication systems. For one, conventional authentication methods often rely on centralized databases or cloud-based verification systems, which introduce vulnerabilities related to network connectivity, server availability, and potential data breaches. Furthermore, many existing optical authentication approaches require specialized equipment or proprietary readers, limiting their accessibility and increasing implementation costs. In many cases, authentication systems depend on the secrecy of algorithms or the distribution of encryption keys, creating security risks when these mechanisms become compromised. Additionally, traditional security features such as watermarks, holograms, or special inks can be replicated by sophisticated counterfeiters, and visual inspection methods are subjective and may not provide adequate protection against advanced counterfeiting techniques. The lack of self-contained verification capabilities in existing systems restricts their utility in scenarios where network access is unavailable or unreliable, limiting their effectiveness in global supply chain protection and field authentication applications. These unresolved issues and technical problems underscore the pressing demand for improved authentication systems that combine physical unclonable functions with cryptographic security while maintaining accessibility through commonly available mobile devices.

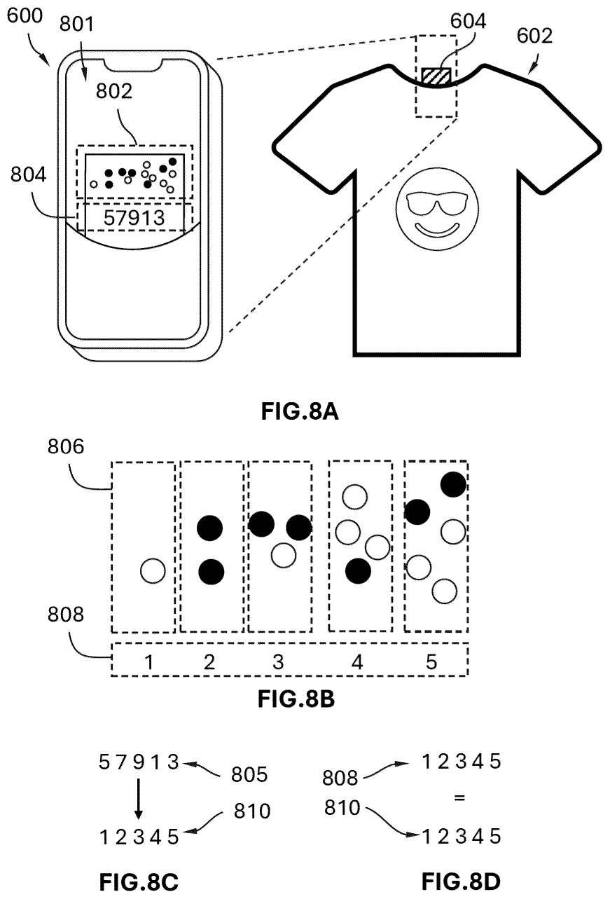

Referring to FIGS. 8A-8D, a system for authenticating a physical item may include several components that work together to provide secure verification without requiring external database access. The system may comprise an upconverting phosphor (UCP) layer, a covert marking, and a mobile device with specific subcomponents configured to perform authentication operations.

As shown in FIG. 8A, a mobile device 600 may be positioned to capture authentication data from a tag 604 attached to a product 602. The mobile device 600 may include a display screen 601 and may be configured as a smartphone or similar handheld device. The product 602 may be depicted as a garment such as a t-shirt, and a tag 604 may be attached to the product 602 in a location such as near a collar area. An image 801 may be visible within the tag 604, and the image 801 may contain a lightmap region 802 and a covert marking 804.

The upconverting phosphor layer may be disposed on the physical item and may be configured to emit visible light upon near-infrared excitation.

As used herein, the term “near-infrared” may refer to electromagnetic radiation with wavelengths in the range of approximately 700 nanometers to 2500 nanometers, which lies between the visible light spectrum and the mid-infrared region. Near-infrared radiation may be characterized by wavelengths that are longer than visible red light but shorter than thermal infrared radiation. In some cases, near-infrared may specifically refer to wavelengths between 700 nanometers and 1400 nanometers, which corresponds to the region where many upconverting phosphor materials exhibit absorption characteristics suitable for excitation purposes. In a preferred embodiment, the wavelengths used to excite one or more phosphors may be wavelengths between 900 nanometers and 1000 nanometers, such as around 940 nanometers or around 980 nanometers. Near-infrared radiation may be substantially invisible to human vision under normal conditions but can be detected by appropriate sensors and may be emitted by various light sources including laser diodes, light-emitting diodes, and vertical-cavity surface-emitting lasers. The near-infrared spectrum may be particularly suitable for authentication applications because it can penetrate certain materials while remaining covert to casual observation, and many upconverting phosphor compositions may efficiently absorb near-infrared photons and convert them to visible light emissions through upconversion processes.

As illustrated in FIG. 8A, the lightmap region 802 may comprise multiple phosphor particles that emit visible light when excited by near-infrared illumination from the mobile device 600. The lightmap region 802 may be represented by a pattern of dots or particles distributed across a defined region within the tag 604.

The covert marking 804 may be printed on the physical item and may represent an encrypted code derived from a pattern of emission points of the UCP layer. As shown in FIG. 8A, the covert marking 804 may be visible within the image 801 on the tag 604 alongside the lightmap region 802. The covert marking may comprise various forms of discrete marking technologies that allow the encrypted code to be captured and read by the mobile device 600.

With continued reference to FIGS. 8A-8D, the mobile device 600 may comprise a near-infrared vertical-cavity surface-emitting laser (VCSEL), an optical sensor, and one or more processing units. The mobile device 600 may be configured to perform multiple authentication operations through the processing units. The VCSEL may emit light to excite the UCP layer, and the excitation of the UCP layer may emit light that forms a lightmap. The optical sensor may capture at least one image of a physical item 800. Each image may include the covert marking 804, the lightmap region 802, or both (both the covert marking and the lightmap must be captured, but they may appear on the same image or on different images). In some implementations, if multiple images are used, the images may be captured at or about the same time, and may occur in any order. In some implementations, a first image of the lightmap is captured, and after the numerical sequence S′ is generated, a second image of the covert marking may be captured.

As illustrated in FIG. 8B, the lightmap region 802 may be divided into a plurality of sectors 806 for digitization purposes. The sectors 806 may be arranged in a grid pattern, and each sector 806 may contain a different number of emission points represented by filled circles and unfilled circles. A first sector 1, a second sector 2, a third sector 3, a fourth sector 4, and a fifth sector 5 may be shown horizontally across the lightmap region 802. The processing units may digitize counts of the emission points falling within each of the plurality of defined sectors 806 to form a numerical sequence S′ 808.

As shown in FIG. 8C, the processing units may read an encrypted sequence C 805 from the covert marking and may decrypt the encrypted code using a rotor-based algorithm to produce a decrypted sequence D 810. The encrypted sequence C 805 may be represented by a numerical sequence such as “57913”, and the decrypted sequence D 810 may be represented by a numerical sequence such as “12345” after applying the rotor-based decryption algorithm.

As illustrated in FIG. 8D, the processing units may compare the numerical sequence S′ 808 to the decrypted sequence D 810 to determine authenticity. The numerical sequence S′ 808 may be shown as “12345” and the decrypted sequence D 810 may also be shown as “12345”, with an equals sign positioned between them to indicate the comparison process. When the numerical sequence S′ 808 matches the decrypted sequence D 810, the system may confirm authenticity of the physical item 800.

### Upconverting Phosphor (UCP) Layer

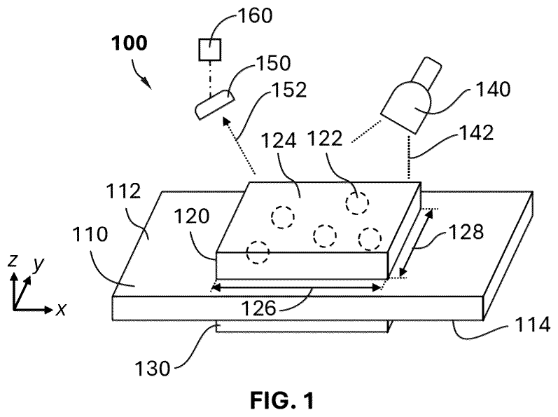

Referring to FIG. 1, an authentication system 100 may include a base substrate 110 having a first surface 112 and a second surface 114 opposite the first surface 112. A phosphor layer 120 may be operably coupled to the first surface 112 of the base substrate 110. The phosphor layer 120 may include phosphors 122 disposed within a radiation transparent matrix material 124. The phosphor layer 120 may have a length 126 and a width 128 extending along the first surface 112 of the base substrate 110.

The upconverting phosphor layer may be configured to emit visible light upon near-infrared excitation. As shown in FIG. 1, a light source 140 may be positioned to emit excitation light 142 directed toward the phosphor layer 120. When the phosphors 122 absorb the excitation light 142, the phosphor layer 120 may emit emission light 152 at wavelengths different from the excitation wavelengths. A sensor 150 may be positioned to receive the emission light 152 emitted from the phosphor layer 120, and the sensor 150 may be operably coupled to a processing unit 160 configured to analyze the captured emission light 152.

The phosphors 122 may be homogeneously or heterogeneously disposed within the phosphor layer 120. In some cases, the phosphors 122 may be randomly disposed within the phosphor layer 120 to create unique spatial distributions. In other cases, the phosphors 122 may be disposed in specific locations within the phosphor layer 120 to form predetermined patterns or arrangements.

The radiation transparent matrix material 124 may be polymeric, such as polyethylene or polypropylene. The radiation transparent matrix material 124 may have at least 75% transmittance at specific wavelengths corresponding to the excitation and emission wavelengths of the phosphors 122. In some cases, the radiation transparent matrix material 124 may have at least 80%, at least 85%, at least 90%, or at least 95% transmittance at the relevant wavelengths to allow efficient light transmission to and from the phosphors 122.

The phosphor layer 120 may have the same length 126 and width 128 as the base substrate 110. In some cases, the phosphor layer 120 may have smaller dimensions than the base substrate 110, covering only a portion of the first surface 112.

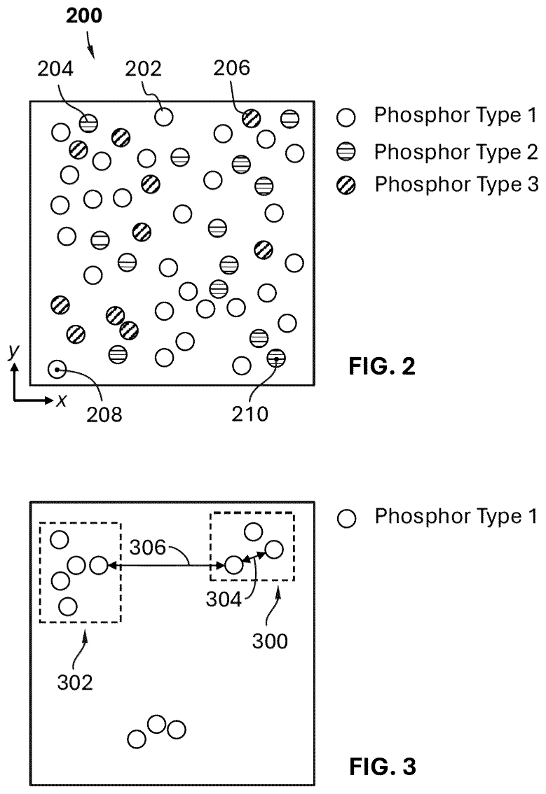

Referring to FIG. 2, a lightmap 200 may illustrate the spatial distribution of different phosphor types across a two-dimensional surface. The lightmap 200 may include a first phosphor 202, a second phosphor 204, and a third phosphor 206, each represented by different visual markers. The phosphors may have different emission characteristics including peak emission wavelength, rise time, and decay time. For example, the first phosphor 202 may emit at a blue wavelength with a relatively fast rise time and a relatively slow decay rate, while the second phosphor 204 may emit at a red wavelength with different temporal characteristics.

The UCP layer may contain phosphors having distinct decay-time and spectral signatures. The mobile device 600 may form part of the numerical sequence S′ 808 based on the distinct decay-time and spectral signatures measured during the authentication process. The emission points in the UCP layer may consist of a plurality of types of phosphors, each contributing different optical characteristics to the overall lightmap pattern.

A first center 208 and a second center 210 may be indicated within the lightmap 200 to mark center positions of phosphor particles. These center points may serve as reference locations for establishing coordinate systems or for spatial mapping of the phosphor distribution pattern within the lightmap 200. The origin of x-y positions may be the center of the image or may be based on a phosphor closest to a particular location.

With continued reference to FIG. 3, the phosphors may form clusters where spatial arrangements create distinct groupings. A first cluster 300 and a second cluster 302 may comprise multiple phosphor particles arranged in close proximity to one another. An average distance 304 may represent the typical spacing between adjacent phosphors within the first cluster 300. A minimum distance 306 may extend between the nearest phosphor particles of the two clusters, where the minimum distance 306 may be substantially larger than the average distance 304.

The minimum distance 306 between phosphors from adjacent clusters may be at least 2 times the average distance 304 between phosphors in a cluster. In some cases, the minimum distance 306 may be at least 2.5 times, at least 3 times, at least 4 times, or at least 5 times the average distance 304 to create well-separated cluster formations.

The UCP layer may comprise micro-to nano-scale rare-earth-doped phosphor particles. In some cases, the phosphor particles may include compositions such as NaYF₄:Yb, Er or Y₂O₂S:Eu. These rare-earth-doped materials may provide upconversion properties that allow absorption of near-infrared radiation and emission of visible light wavelengths suitable for detection by the mobile device 600 and the sensor 150.

### Radiation Blocking Layer and Additional Physical Item Features

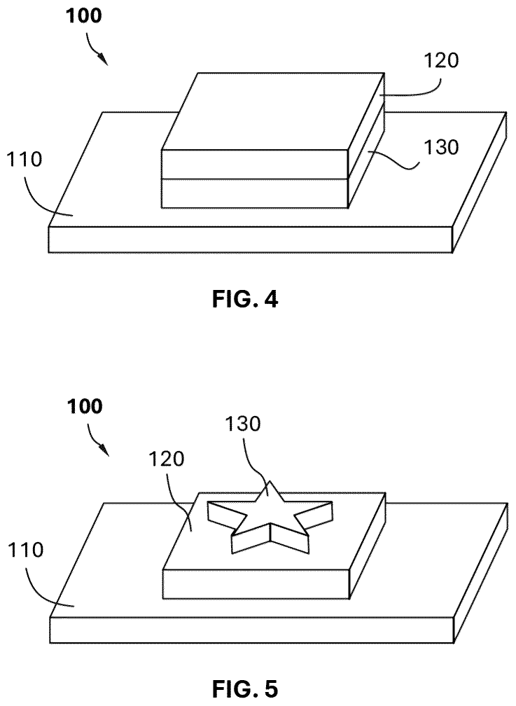

Referring to FIG. 4, the authentication system 100 may further include a radiation blocking layer 130 as an optional feature. The radiation blocking layer 130 may be operably coupled to the base substrate 110 and may be positioned between the base substrate 110 and the phosphor layer 120. In this configuration, the radiation blocking layer 130 may be disposed on top of the base substrate 110, with the phosphor layer 120 positioned on top of the radiation blocking layer 130. This stacked arrangement may position the radiation blocking layer 130 as an intermediate layer that affects the directionality of light transmission within the authentication system 100.

The radiation blocking layer 130 may be configured to absorb excitation wavelengths of light, thereby preventing light from reaching the phosphor layer 120 when the authentication system 100 is oriented such that incident light encounters the radiation blocking layer 130 first. The radiation blocking layer 130 may be provided as a film or ink that can be applied to various surfaces of the base substrate 110.

As shown in FIG. 5, the radiation blocking layer 130 may alternatively be disposed over the phosphor layer 120, positioning the phosphor layer 120 between the base substrate 110 and the radiation blocking layer 130. In this configuration, the radiation blocking layer 130 may be positioned on the opposite side of the phosphor layer 120 from the base substrate 110. The radiation blocking layer 130 may be formed with a star-shaped pattern, demonstrating that the blocking layer can be configured in various geometric configurations beyond simple rectangular or circular shapes.

The radiation blocking layer 130 may have a larger area in an x-y plane as compared to the phosphor layer 120. In some cases, the radiation blocking layer 130 may have the same area in the x-y plane as compared to the phosphor layer 120. In other cases, the radiation blocking layer 130 may have a smaller area in the x-y plane as compared to the phosphor layer 120, allowing selective coverage of the phosphor layer 120.

The radiation blocking layer 130 may have the same shape as the phosphor layer 120, where both layers may be rectangular, circular, or other matching geometric forms. In some cases, the radiation blocking layer 130 may have a different shape than the phosphor layer 120, as illustrated in FIG. 5 where the radiation blocking layer 130 has a star shape while the phosphor layer 120 maintains a rectangular configuration.

The radiation blocking layer 130 may form a patterned shape where the patterned shape blocks incident light while other portions of the shape allow light to reach the phosphor layer 120. This patterned configuration may enable selective blocking of incident light, creating regions where certain areas are blocked while other regions permit light transmission to the phosphor layer 120. The patterned blocking layer may provide controlled access to different portions of the phosphor layer 120 based on the orientation and positioning of the authentication system 100.

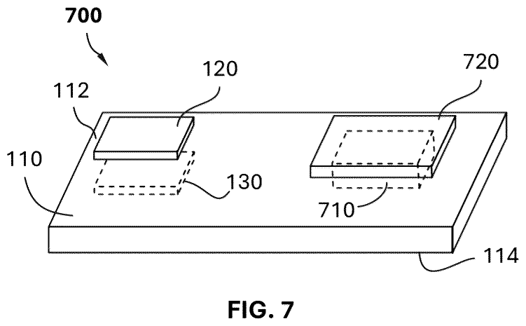

Referring to FIG. 7, a physical item 700 may incorporate multiple authentication layers and features. The physical item 700 may include the base substrate 110 having the first surface 112 and the second surface 114. The phosphor layer 120 may be operably coupled to a portion of the first surface 112 of the base substrate 110. The radiation blocking layer 130 may be operably coupled to the second surface 114 of the base substrate 110, providing an alternative positioning configuration where the radiation blocking layer 130 is located on the opposite side of the base substrate 110 from the phosphor layer 120.

The physical item 700 may further include a transparent window 710 that extends through the base substrate 110 from the first surface 112 to the second surface 114. The transparent window 710 may contain a separate embedded phosphor layer that provides additional authentication capabilities. The transparent window 710 may be configured to be visible under transmitted infrared light while remaining non-visible in reflected light.

An optically variable coating 720 may be disposed over at least one surface of the transparent window 710. The optically variable coating 720 may be configured to be transparent to transmitted light to or from the phosphors in the embedded phosphor layer within the transparent window 710, but may be opaque to reflected light. This configuration may allow the transparent window 710 to exhibit transparency when viewed through transmitted light while exhibiting opacity for reflected light, providing additional dynamic security features.

The arrangement of the phosphor layer 120, the radiation blocking layer 130, the transparent window 710, and the optically variable coating 720 may provide multiple authentication features within the single physical item 700. The system may be free of the radiation blocking layer 130 and the transparent window 710 in some configurations, where authentication relies primarily on the upconverting phosphor layer and covert marking components. The combination of phosphor-based verification with optical variability may enhance security through multiple independent verification mechanisms.

### Covert Marking

A covert marking may be incorporated (e.g., printed, engraved, etc.) on the physical item and may represent an encrypted code derived from a pattern of emission points of the UCP layer.

As used herein, the term “covert marking” may refer to a discrete marking, pattern, or code that is applied to a physical item and remains substantially invisible or difficult to detect under ordinary viewing conditions. A covert marking may be implemented using various technologies including microtext printing, ultraviolet-visible inks, infrared-absorptive inks, nano-dot patterning, laser micro-engraving, or combinations thereof. The covert marking may encode information such as encrypted sequences, authentication data, or reference patterns that can be detected and read using appropriate detection equipment or illumination conditions. The covert marking may serve as a cryptographic representation of unique physical characteristics of the item, allowing verification without requiring access to external databases or reference materials. The marking may remain hidden during normal handling and use of the item while becoming detectable when subjected to specific optical, electromagnetic, or mechanical detection methods during authentication processes.

The covert marking may serve as a cryptographic representation of the unique phosphor distribution pattern, allowing the authentication system to perform verification without requiring access to external databases or reference materials.

The covert marking may comprise microtext printing, UV-visible ink, IR-absorptive ink, nano-dot patterning, laser micro-engraving, or a combination thereof. Each of these covert marking technologies may provide different advantages for specific applications and manufacturing requirements. The system may be free of any particular covert marking technology, allowing flexibility in implementation based on available manufacturing capabilities and security requirements.

Microtext printing may involve the application of extremely small text characters that are difficult to reproduce without specialized printing equipment. The microtext may encode the encrypted sequence in alphanumeric format, where the characters may be sized below the resolution limits of standard copying or scanning equipment. Microtext printing may be applied using conventional printing processes while maintaining the covert nature of the marking.

UV-visible ink may provide a covert marking that remains invisible under ordinary lighting conditions but becomes visible when exposed to ultraviolet illumination. The UV-visible ink may contain fluorescent compounds that emit visible light when excited by UV radiation, allowing the encrypted code to be revealed only when appropriate excitation is applied. This approach may provide an additional layer of security by requiring specific illumination conditions for code detection.

IR-absorptive ink may absorb infrared radiation while remaining transparent or nearly transparent to visible light. The IR-absorptive ink may create contrast patterns that can be detected by infrared-sensitive sensors while remaining substantially invisible to human visual inspection under ordinary lighting. This technology may allow the covert marking to be integrated with the near-infrared excitation system used for the UCP layer activation.

Nano-dot patterning may involve the creation of extremely small dots or patterns that encode the encrypted sequence through spatial arrangements or density variations. The nano-dots may be applied using precision printing or deposition techniques, creating markings that are below the resolution limits of standard reproduction methods. The nano-dot patterns may be detected using high-resolution optical sensors while remaining substantially invisible to casual inspection.

Laser micro-engraving may create physical surface modifications that encode the encrypted sequence through variations in surface texture or reflectivity. The laser micro-engraving process may produce markings with precise dimensional control and high durability, making the covert marking resistant to wear and environmental conditions. The engraved patterns may be detected through optical scanning techniques that analyze surface characteristics.

The covert marking may be invisible or only partially visible under ordinary lighting conditions. This characteristic may allow the physical item to maintain normal appearance during routine handling while preserving the security features for authentication purposes. The reduced visibility under ordinary lighting may prevent casual detection of the covert marking, maintaining the security of the encrypted code until authentication is performed using appropriate detection equipment.

The encrypted code represented by the covert marking may be derived from the pattern of emission points of the UCP layer through digitization and encryption processes. The derivation process may involve analyzing the spatial distribution of phosphor particles, quantifying their positions and characteristics, and applying cryptographic algorithms to generate the encrypted representation. The resulting encrypted code may be mathematically linked to the physical phosphor pattern while being computationally difficult to reverse-engineer without access to the appropriate decryption algorithms.

### Mobile Device Components

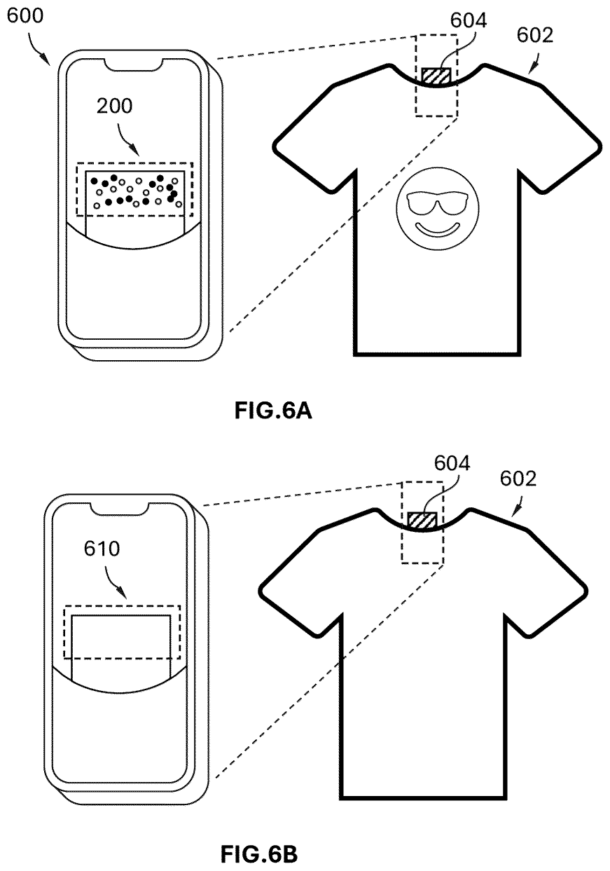

Referring to FIG. 6A, the mobile device 600 may comprise a near-infrared vertical-cavity surface-emitting laser (VCSEL), an optical sensor, and one or more processing units configured to perform authentication operations. The mobile device 600 may be positioned to capture authentication data from the tag 604 attached to the product 602. The mobile device 600 may include the display screen 601 and may be configured as a smartphone or similar handheld device capable of optical detection and image processing.

The near-infrared VCSEL may be configured to emit light at wavelengths suitable for exciting the upconverting phosphor layer. The VCSEL may emit light at wavelengths such as 800 nm or 940 nm, which may be absorbed by the phosphors 122 in the phosphor layer 120 to produce visible light emissions. The VCSEL may provide controlled illumination with precise wavelength characteristics and sufficient power density to activate the upconverting phosphors across the lightmap region 802.

The optical sensor may be configured to capture images of the physical item during the authentication process. The optical sensor may comprise a camera system with sensitivity to both the visible light emissions from the upconverting phosphors and the covert marking 804 applied to the tag 604. The optical sensor may have sufficient resolution to detect individual emission points within the lightmap region 802 and to read the encrypted code from the covert marking 804.

The one or more processing units may be configured to perform multiple authentication operations collectively. The processing units may cause the VCSEL to emit light to excite the UCP layer, where the excitation of the UCP layer may emit light that forms the lightmap. The processing units may capture at least one image of the physical item containing the covert marking 804 and the lightmap region 802 through control of the optical sensor.

The mobile device 600 may be configured to provide a visible verification indicator or match score on the device display. The display screen 601 may present authentication results to a user through visual indicators that communicate the verification status of the physical item. The visible verification indicator may include graphical elements such as checkmarks, color-coded status indicators, or textual messages that indicate whether authentication was successful or failed. The match score may provide a numerical or percentage-based representation of the similarity between the numerical sequence S′ 808 and the decrypted sequence D 810, allowing users to assess the confidence level of the authentication result.

The encryption and decryption algorithms may be implemented within a dedicated mobile application stored on the mobile device 600. The dedicated mobile application may contain the rotor-based algorithm software and associated cryptographic functions needed to decrypt the encrypted code from the covert marking 804. The mobile application may be installed on the mobile device 600 and may operate independently of network connectivity, allowing authentication to be performed in offline environments.

The system may be free of visible verification indicators or match scores on the device display in some configurations. In such cases, the authentication process may provide results through alternative means such as audio signals, haptic feedback, or simple binary indicators. The system may also be free of a dedicated mobile application, where the encryption and decryption algorithms may be implemented through web-based applications, integrated device software, or other software architectures.

As shown in FIG. 6B, the mobile device 600 may be used to verify the physical item from different orientations to demonstrate the dual-sided verification capability of the authentication system. The product 602 may be shown with the tag 604 in a reverse orientation compared to FIG. 6A. In this configuration, an area 610 on the tag 604 may be indicated where the phosphor layer would be expected to emit visible light when excited by near-infrared illumination from the mobile device 600.

When the tag 604 is oriented as shown in FIG. 6B, the radiation blocking layer 130 may be positioned between the light source and the phosphor layer 120, preventing the excitation light 142 from reaching the phosphors 122. This orientation may result in no optical response from the area 610, demonstrating the absence of emissions when the radiation blocking layer 130 blocks the incident light. The mobile device 600 may detect this lack of optical response and may use the absence of emissions as part of the authentication verification process.

The dual-sided verification process may involve capturing images from both orientations shown in FIG. 6A and FIG. 6B. The processing units may analyze the presence of emissions in the first orientation and the absence of emissions in the second orientation to confirm both the presence of the phosphor layer 120 and the radiation blocking layer 130. This two-sided verification may provide additional security by confirming that both authentication components are present and functioning as expected within the tag 604.

The one or more processing units may be configured to perform coordinated processing operations that enable authentication through optical excitation and image capture. These processing operations may involve precise control of the VCSEL and optical sensor to generate and detect the lightmap pattern while simultaneously capturing the covert marking for subsequent analysis.

The processing units may cause the VCSEL to emit light to excite the UCP layer through controlled activation sequences. The processing units may initiate VCSEL operation by applying appropriate electrical signals that generate near-infrared radiation at wavelengths suitable for upconverting phosphor excitation. The VCSEL emission may be controlled in terms of power output, pulse duration, and timing to provide optimal excitation conditions for the upconverting phosphors within the UCP layer.

When the VCSEL emits light toward the UCP layer, the upconverting phosphors may absorb the near-infrared radiation and convert the absorbed energy to visible light emissions through upconversion processes. The excitation of the UCP layer may emit light that forms a lightmap, where the lightmap represents the spatial distribution of activated phosphor particles across the illuminated region. The lightmap formation may occur within milliseconds of VCSEL activation, creating a visible pattern that corresponds to the unique arrangement of upconverting phosphors within the UCP layer.

The processing units may coordinate the timing between VCSEL activation and image capture to ensure optimal detection of the lightmap pattern. The coordination may involve synchronizing the VCSEL emission with the optical sensor operation to capture images during peak phosphor emission periods. The processing units may account for the rise time and decay characteristics of different phosphor types to determine appropriate capture timing windows.

The processing units may capture at least one image of the physical item containing the covert marking and the lightmap through control of the optical sensor. The image capture operation may involve activating the optical sensor to record both the visible light emissions from the excited UCP layer and the covert marking applied to the physical item. The processing units may configure the optical sensor parameters such as exposure time, gain settings, and focus adjustments to optimize detection of both the lightmap pattern and the covert marking within a single image or multiple sequential images.

The image capture process may involve acquiring digital image data that contains pixel information corresponding to the spatial locations of activated phosphor particles within the lightmap. The processing units may control the optical sensor to capture images with sufficient resolution to distinguish individual emission points or clusters of emission points within the lightmap region. The captured image data may include intensity information for each pixel location, allowing the processing units to identify and quantify the emission characteristics of the phosphor particles.

The processing units may capture images that contain both the lightmap and the covert marking simultaneously or through sequential capture operations. In simultaneous capture, the processing units may configure the optical sensor to detect both the visible light emissions from the phosphors and the covert marking within a single exposure. In sequential capture, the processing units may perform separate image acquisition operations optimized for detecting the lightmap pattern and the covert marking respectively.

The processing operations may enable detection of the phosphor emission pattern for subsequent analysis by generating digital representations of the lightmap that can be processed using computational algorithms. The captured image data may preserve the spatial relationships between emission points, allowing the processing units to perform sector-based counting and pattern analysis operations. The image capture may provide sufficient data quality to support accurate digitization of the phosphor distribution pattern and reliable reading of the encrypted code from the covert marking.

The processing units may implement image preprocessing operations to enhance the detection of the phosphor emission pattern within the captured images. These preprocessing operations may include noise reduction, contrast enhancement, and background subtraction to improve the signal-to-noise ratio of the phosphor emissions relative to ambient lighting conditions. The preprocessing may facilitate more accurate identification of emission points and more reliable extraction of the covert marking information.

The VCSEL excitation and image capture operations may be performed multiple times during a single authentication session to improve measurement reliability and account for variations in positioning or environmental conditions. The processing units may capture multiple images under different excitation conditions or from slightly different angles to ensure comprehensive detection of the phosphor emission pattern. The multiple capture approach may provide redundancy that enhances the robustness of the authentication process against variations in device positioning or ambient lighting conditions.

The processing units may digitize counts of the emission points falling within each of a plurality of defined sectors of the image of the lightmap to form a numerical sequence S′. This digitization process may involve computational analysis of the captured image data to identify and quantify the spatial distribution of activated phosphor particles across the lightmap region.

The digitization operation may begin with the processing units dividing the lightmap image into a plurality of defined sectors. Each defined sector may represent a discrete spatial region within the overall lightmap area, where the sectors collectively cover the region of interest for phosphor emission detection. The defined sectors may be configured as geometric shapes such as rectangles, squares, circles, or other regular or irregular polygonal forms that facilitate systematic analysis of the phosphor distribution pattern.

The emission region may be segmented into multiple sectors, such as 10-200, such as 25-100 discrete sectors to provide appropriate spatial resolution for pattern analysis while maintaining computational efficiency. The selection of sector count within this range may depend on factors such as the size of the lightmap region, the density of phosphor particles, and the desired authentication security level. A lower sector count such as 25 sectors may provide faster processing and reduced computational requirements, while a higher sector count approaching 100 sectors may offer enhanced pattern discrimination and increased security against counterfeiting attempts.

The processing units may implement sector division algorithms that automatically determine sector boundaries based on the dimensions and characteristics of the captured lightmap image. The sector division may involve mathematical calculations that partition the image area into equal-sized regions or may use adaptive algorithms that adjust sector sizes based on the local density of emission points. The sector boundaries may be defined using coordinate systems that specify the spatial limits of each sector within the image coordinate framework.

At least some of the defined sectors may overlap in certain system configurations. Overlapping sectors may provide enhanced spatial sampling by allowing emission points near sector boundaries to contribute to multiple sector counts. The overlapping configuration may reduce sensitivity to small variations in phosphor positioning or image alignment by ensuring that emission points are consistently detected even when located near the edges of individual sectors. The degree of overlap between adjacent sectors may be configured as a percentage of sector area or as a fixed distance measurement.

In alternative configurations, the defined sectors may be free of overlap, where each sector occupies a distinct spatial region without sharing area with adjacent sectors. Non-overlapping sectors may provide computational advantages by ensuring that each emission point contributes to exactly one sector count, simplifying the digitization algorithms and reducing processing requirements. The non-overlapping configuration may also provide clearer spatial discrimination between different regions of the lightmap pattern.

The system may be configured such that all emission points are within the defined sectors. This configuration may ensure comprehensive coverage of the lightmap region by positioning the sector boundaries to encompass the entire area where phosphor emissions may occur. Complete coverage may prevent loss of authentication information that could result from emission points falling outside the defined sector boundaries. The processing units may implement boundary detection algorithms that automatically adjust sector positioning to ensure that all detected emission points fall within at least one defined sector.

The processing units may count the emission points within each defined sector by analyzing pixel intensity values and applying threshold detection algorithms. The counting operation may involve identifying pixels or pixel clusters that exceed predetermined intensity thresholds, indicating the presence of activated phosphor particles. The processing units may implement image processing techniques such as blob detection, peak finding, or connected component analysis to accurately identify and count discrete emission points within each sector.

The emission point counting may account for variations in phosphor particle size, emission intensity, and clustering behavior. Individual phosphor particles may appear as single pixels or small pixel clusters in the captured image, while larger phosphor aggregates may produce more extensive emission regions. The processing units may implement algorithms that normalize the counting process to account for these size variations, ensuring consistent quantification across different phosphor configurations.

The processing units may form the numerical sequence S′ by organizing the sector counts into a structured data format that uniquely characterizes the physical sample. The numerical sequence S′ may comprise an ordered array of integer values, where each value represents the count of emission points detected within a corresponding sector. The ordering of values within the sequence may follow a predetermined pattern such as left-to-right and top-to-bottom scanning of the sectors, or may use alternative ordering schemes that facilitate subsequent comparison operations.

The numerical sequence S′ may serve as a digital fingerprint that characterizes the unique spatial distribution of phosphor particles within the lightmap. The sequence may capture both the local density variations and the overall pattern characteristics of the phosphor arrangement, providing a quantitative representation that can be compared against decrypted reference data during the authentication process. The digitization process may preserve the spatial relationships between different regions of the lightmap while converting the optical pattern into a format suitable for cryptographic comparison operations.

### Processing Operations: Reading and Decrypting the Encrypted Code

The processing units may read the encrypted code from the covert marking through optical character recognition and image analysis operations. The reading process may involve analyzing the captured image data to identify and extract the encrypted code information that has been applied to the physical item through the covert marking. The processing units may implement pattern recognition algorithms that can detect and interpret various forms of covert marking technologies including microtext printing, UV-visible ink, IR-absorptive ink, nano-dot patterning, and laser micro-engraving.

The encrypted code reading operation may begin with the processing units identifying the spatial location of the covert marking within the captured image. The covert marking may be positioned at predetermined locations relative to the lightmap region, allowing the processing units to search for the encrypted code within specific image regions. The processing units may implement template matching algorithms or feature detection methods to locate the covert marking boundaries and extract the relevant image data for subsequent analysis.

The processing units may apply image enhancement techniques to improve the visibility and readability of the encrypted code within the covert marking. These enhancement operations may include contrast adjustment, noise filtering, and edge sharpening to optimize the signal-to-noise ratio of the covert marking relative to the background substrate material. The image enhancement may be particularly beneficial when the covert marking has low contrast or when ambient lighting conditions affect the visibility of the encrypted code.

The processing units may implement optical character recognition algorithms specifically configured for the format and characteristics of the encrypted code. The optical character recognition may be adapted to handle various encoding formats such as alphanumeric sequences, binary patterns, or specialized symbol sets used in the covert marking. The recognition algorithms may account for the size, font characteristics, and spacing of the encrypted code elements to ensure accurate extraction of the code information.

The processing units may decrypt the encrypted code using a rotor-based algorithm to produce the decrypted sequence D. The rotor-based algorithm may implement cryptographic operations that reverse the encryption process applied during manufacturing to recover the original pattern information. The decryption process may involve mathematical transformations that convert the encrypted code back to a numerical sequence that can be compared against the digitized lightmap data.

The rotor-based encryption algorithm may comprise multiple logical rotors having independently variable offsets and a manufacturing seed key. The multiple logical rotors may function as virtual mechanical rotors that apply sequential transformations to the input data during encryption and decryption operations. Each logical rotor may implement a substitution cipher with a unique offset value that determines the mapping between input and output characters or numerical values. The independently variable offsets may allow each rotor to operate with different transformation parameters, increasing the complexity and security of the encryption algorithm. Output from the encryption algorithm may be an encrypted sequence C=f(S, key), which may be converted to, e.g., an alphanumeric or dot-matrix code that can then be incorporated as the covert marking onto a physical item.

The system may be free of multiple logical rotors in some configurations, where the rotor-based algorithm may implement a single rotor or alternative cryptographic approaches. The system may also be free of independently variable offsets, where the rotor operations may use fixed offset values or predetermined offset sequences. The system may be free of a manufacturing seed key, where the encryption algorithm may rely on alternative key generation methods or predetermined cryptographic parameters.

The manufacturing seed key may provide initialization parameters that configure the rotor-based algorithm for the specific physical item being authenticated. The manufacturing seed key may be derived from manufacturing data such as production batch information, timestamp data, or unique identifiers associated with the manufacturing process. The seed key may ensure that each physical item receives a unique encryption configuration that corresponds to its specific phosphor pattern and manufacturing characteristics.

The key initialization derived from manufacturing data may involve computational processes that generate cryptographic parameters based on measurable or recordable aspects of the manufacturing process. The manufacturing data may include information such as production line identifiers, manufacturing date and time, environmental conditions during production, or quality control measurements. The processing units may implement key derivation functions that convert this manufacturing data into cryptographic parameters suitable for configuring the rotor-based algorithm.

The rotor-based algorithm may use variable offsets that change during the encryption and decryption processes. The variable offsets may be determined by the manufacturing seed key and may follow predetermined sequences or mathematical functions that modify the rotor positions as the algorithm processes each element of the input data. The variable offset approach may provide enhanced security by ensuring that identical input values may produce different encrypted outputs depending on their position within the sequence.

The decryption process may involve applying the inverse transformations of the encryption algorithm to recover the original numerical sequence from the encrypted code. As an overly simplified example, as shown in FIGS. 8A-8D, an original sequence 12345 may be processed through the rotor-based encryption algorithm to produce an encrypted sequence 57913, demonstrating the transformation applied during manufacturing. During authentication, the processing units may read the encrypted sequence 57913 from the covert marking and apply the rotor-based decryption algorithm to recover the original sequence 12345 as the decrypted sequence D.

The rotor-based algorithm may implement substitution operations where each numerical digit or character in the input sequence is replaced with a corresponding output value based on the current rotor configuration. The substitution mapping may change as the algorithm progresses through the input sequence, with the rotor offsets advancing according to predetermined rules or mathematical functions. The advancing rotor positions may ensure that repeated input values produce different encrypted outputs, enhancing the security of the encryption scheme.

The processing units may implement the rotor-based algorithm through software operations that simulate the mechanical rotor behavior using computational methods. The software implementation may maintain rotor state information including current offset values, advancement rules, and substitution tables for each logical rotor. The processing units may execute the rotor operations sequentially, processing each element of the encrypted code through the configured rotor transformations to produce the corresponding elements of the decrypted sequence D.

The decrypted sequence D may comprise a numerical sequence that corresponds to the expected sector counts from the lightmap digitization process. The decrypted sequence D may have the same format and structure as the numerical sequence S′ generated from the captured lightmap image, allowing direct comparison between the two sequences during the authentication verification process. The successful decryption of the encrypted code may produce the decrypted sequence D that matches the original pattern information encoded during manufacturing.

The rotor-based algorithm may provide computational security through the complexity of the rotor interactions and the dependency on the manufacturing seed key. The algorithm may be designed to be computationally difficult to reverse-engineer without access to the appropriate decryption parameters, providing protection against counterfeiting attempts that might try to generate valid encrypted codes without access to the original phosphor patterns. The rotor-based approach may offer advantages over simpler encryption methods by providing multiple layers of transformation that increase the difficulty of cryptographic attacks.

The processing units may compare numerical sequence S′ to decrypted sequence D to determine authenticity through computational analysis operations that evaluate the correspondence between the captured lightmap pattern and the encrypted reference data. The comparison process may involve mathematical operations that quantify the similarity between the two numerical sequences and apply decision criteria to determine whether the physical item passes authentication verification.

The comparison operation may begin with the processing units aligning the numerical sequence S′ and the decrypted sequence D to ensure proper correspondence between sector counts and reference values. The alignment process may account for potential variations in sector ordering or indexing that could affect the comparison results. The processing units may implement sequence matching algorithms that identify the optimal alignment between the two sequences to maximize the accuracy of the similarity assessment.

The processing units may calculate difference metrics that quantify the discrepancies between corresponding elements of the numerical sequence S′ and the decrypted sequence D. The difference metrics may include various mathematical measures such as absolute differences, squared differences, or normalized difference calculations that provide quantitative assessments of the similarity between the sequences. The difference metric calculations may be performed element-wise across all corresponding positions within the two sequences.

Authentication may be confirmed when a difference metric between numerical sequence S′ and decrypted sequence D is within a predefined statistical tolerance. The predefined statistical tolerance may establish acceptable limits for variations between the captured lightmap pattern and the reference pattern encoded in the encrypted code. The statistical tolerance may account for factors such as measurement noise, positioning variations, environmental conditions, and natural variations in phosphor emission characteristics that may affect the consistency of sector count measurements.

The authentication process may use a statistical tolerance function where if |S′-D|≤a predetermined threshold, the physical item is authentic. This mathematical relationship may define the authentication criterion through an inequality comparison that evaluates whether the absolute difference between the numerical sequences falls within acceptable limits. The threshold value may be predetermined based on empirical testing, statistical analysis of measurement variations, or security requirements that balance authentication accuracy with resistance to false positive results.

The threshold value may be configured as a single numerical parameter that applies uniformly across all sector comparisons, or may comprise multiple threshold values that account for different tolerance requirements in different regions of the lightmap. The processing units may implement threshold comparison algorithms that evaluate the difference metric against the configured threshold values and generate authentication decisions based on the comparison results.

The statistical tolerance function may account for the expected variability in phosphor emission detection and sector counting operations. The tolerance function may be calibrated based on experimental measurements of the repeatability and reproducibility of the lightmap digitization process under various operating conditions. The calibration process may involve statistical analysis of multiple measurements from the same physical item to determine appropriate tolerance limits that maintain authentication security while accommodating normal measurement variations.

The processing units may implement alternative comparison methods that evaluate the overall similarity between the numerical sequences rather than requiring exact matches. These alternative methods may include correlation analysis, pattern matching algorithms, or machine learning approaches that can assess the correspondence between the sequences while accounting for systematic variations or measurement uncertainties. The alternative comparison methods may provide enhanced robustness against variations in device positioning, ambient lighting, or phosphor aging effects.

The system may be free of an active network connection during the authentication process. This configuration may enable offline authentication operations that do not require internet connectivity, cellular data connections, or other network communication capabilities. The offline operation may provide advantages in environments where network access is unavailable, unreliable, or restricted, allowing authentication to be performed in remote locations, secure facilities, or areas with limited communication infrastructure.

The system may be free of a remote database for storing reference lightmap patterns or authentication data. This database-free configuration may eliminate dependencies on external data storage systems, reducing the complexity and cost of system deployment while enhancing security by avoiding potential vulnerabilities associated with centralized data repositories. The absence of remote database requirements may enable fully self-contained authentication operations where all necessary information is embedded within the physical item itself.

In alternative configurations, the mobile device may be operably coupled to a remote database that stores reference authentication data. The remote database coupling may provide access to centralized repositories of lightmap patterns, encryption keys, or other authentication information that supports verification operations. The database coupling may be implemented through network connections such as internet protocols, cellular data networks, or wireless communication systems that enable data exchange between the mobile device and remote storage systems.

When the mobile device is operably coupled to a remote database, the one or more processing units may be further configured to compare a lightmap generated from the at least one image to a lightmap stored on the remote database. This comparison operation may involve transmitting lightmap data from the mobile device to the remote database or retrieving reference lightmap data from the database for local comparison operations. The database-based comparison may provide additional verification capabilities that complement the encrypted code verification process.

The remote database comparison may involve pattern matching algorithms that evaluate the similarity between the captured lightmap and stored reference patterns. The processing units may implement image comparison techniques, statistical correlation methods, or machine learning algorithms that can assess the correspondence between lightmap patterns while accounting for variations in capture conditions or device characteristics. The database comparison may provide enhanced authentication security through multiple independent verification mechanisms.

The processing units may combine the results from both the encrypted code comparison and the remote database comparison to generate comprehensive authentication decisions. The combined approach may require both verification methods to confirm authenticity, or may use weighted scoring systems that consider the results from multiple verification approaches. The multi-method verification may provide enhanced security against sophisticated counterfeiting attempts while maintaining reliability under various operating conditions.

The authentication determination may involve decision logic that processes the comparison results and generates binary authentication outcomes or confidence scores that indicate the likelihood of authenticity. The decision logic may implement threshold-based criteria, statistical analysis methods, or machine learning algorithms that convert the numerical comparison results into actionable authentication decisions. The processing units may generate authentication results in formats suitable for presentation to users or integration with other security systems.

The physical item may be a card, banknote, a clothing hangtag, or a product label. The authentication system may be applied to any of these physical item types to provide secure verification capabilities across diverse applications and industries. Each physical item type may present unique implementation considerations and application scenarios that benefit from the upconverting phosphor layer and covert marking authentication approach.

A card may comprise various types of identification documents, access cards, payment cards, or membership cards that require authentication verification. The card may include credit cards, debit cards, identification cards, driver's licenses, passport cards, employee access cards, or loyalty program cards. The card substrate may be constructed from materials such as plastic, polymer composites, or paper-based materials that can support the application of the upconverting phosphor layer and covert marking. The card format may provide a standardized size and thickness that facilitates consistent manufacturing processes and reliable authentication operations using mobile devices.

Card applications may include financial transaction verification where the authentication system confirms the legitimacy of payment cards before processing transactions. The card authentication may prevent the use of counterfeit payment cards that could otherwise be used for fraudulent transactions. Access control applications may use the authentication system to verify employee identification cards or security badges before granting access to restricted areas or facilities. The card-based authentication may provide enhanced security for physical access control systems by ensuring that only legitimate cards can be used for entry authorization.

A banknote may comprise paper currency, polymer currency, or other forms of legal tender that require protection against counterfeiting. The banknote may include various denominations of national currencies, regional currencies, or specialized monetary instruments such as traveler's checks or money orders. The banknote substrate may be constructed from cotton-based paper, polymer materials, or hybrid substrates that combine multiple material layers to provide durability and security features. The banknote format may accommodate the integration of the upconverting phosphor layer and covert marking alongside existing security features such as watermarks, security threads, or color-changing inks.

Banknote applications may include currency verification at point-of-sale locations where merchants can authenticate paper money before accepting payment. The banknote authentication may be performed using mobile devices to provide immediate verification results without requiring specialized currency detection equipment. Banking applications may use the authentication system to verify currency deposits or to detect counterfeit bills during cash handling operations. The banknote authentication may provide enhanced security for financial institutions by enabling rapid detection of sophisticated counterfeits that might otherwise pass visual inspection.

A clothing hangtag may comprise labels, tags, or attachments that are affixed to garments, accessories, or textile products to provide brand identification, product information, or authenticity verification. The clothing hangtag may include swing tags, sewn-in labels, adhesive labels, or integrated tags that are permanently or temporarily attached to clothing items. The hangtag substrate may be constructed from paper, cardstock, fabric, plastic, or composite materials that can withstand the handling and environmental conditions associated with retail and consumer use. The hangtag format may accommodate various sizes and shapes while maintaining the functionality of the authentication system components.

Clothing hangtag applications may include luxury goods authentication where consumers can verify the authenticity of high-value garments, accessories, or designer items before purchase. The hangtag authentication may help consumers avoid counterfeit products that may have inferior quality or may not provide the expected brand value. Retail applications may use the authentication system to verify inventory authenticity and to prevent the sale of counterfeit merchandise. The hangtag authentication may provide brand protection by enabling retailers to identify and remove counterfeit products from their inventory before they reach consumers.

Supply chain applications may use clothing hangtag authentication to track and verify products throughout the distribution process from manufacturing to retail sale. The hangtag authentication may provide traceability capabilities that help identify the source of counterfeit products and may support enforcement actions against counterfeiting operations. Brand owners may use the authentication system to monitor the distribution of their products and to identify unauthorized sales channels or counterfeit distribution networks.

A product label may comprise adhesive labels, printed labels, or integrated markings that are applied to various consumer products, industrial products, or packaging materials to provide authentication capabilities. The product label may include labels for pharmaceuticals, electronics, automotive parts, food products, cosmetics, or other manufactured goods that require authenticity verification. The label substrate may be constructed from paper, plastic films, foil materials, or specialty substrates that provide appropriate adhesion, durability, and compatibility with the authentication system components. The label format may be customized to accommodate different product shapes, sizes, and application requirements while maintaining the effectiveness of the authentication features.

Product label applications may include pharmaceutical authentication where patients, healthcare providers, or regulatory authorities can verify the authenticity of medications before use. The label authentication may help prevent the distribution and consumption of counterfeit drugs that may be ineffective or dangerous. The pharmaceutical authentication may be particularly valuable in regions where counterfeit medications are prevalent or where supply chain security is a concern.

Electronics authentication applications may use product labels to verify the authenticity of electronic components, devices, or accessories before installation or use. The label authentication may help prevent the use of counterfeit electronic parts that may have reduced performance, reliability, or safety characteristics. The electronics authentication may be valuable for manufacturers, repair services, or end users who need to ensure that replacement parts or components are genuine.

Automotive applications may use product label authentication to verify the authenticity of replacement parts, accessories, or maintenance items. The label authentication may help prevent the installation of counterfeit automotive parts that may compromise vehicle safety, performance, or warranty coverage. The automotive authentication may be used by repair shops, parts distributors, or vehicle owners to ensure that replacement components meet original equipment specifications and quality standards.

Food and beverage applications may use product label authentication to verify the authenticity of premium products, specialty items, or products with specific origin or quality certifications. The label authentication may help consumers identify genuine products and may support brand protection efforts in markets where counterfeit food products are a concern. The food authentication may be particularly valuable for products with high value, specific geographic origins, or specialized production methods.

The authentication system may be used with physical item types beyond cards, banknotes, clothing hangtags, and product labels. The system may be applied to documents such as certificates, diplomas, contracts, or legal papers that require authenticity verification. The system may be used with tickets, passes, or vouchers for events, transportation, or services. The system may be applied to packaging materials, containers, or shipping labels that require supply chain authentication. The versatility of the upconverting phosphor layer and covert marking approach may enable authentication applications across diverse industries and product categories where counterfeiting prevention or authenticity verification provides value.

Preferentially, the authentication systems may not require (or include) remote servers or cloud databases. The authentication systems may be configured to provide offline verification of articles, with zero latency. The system provides a unique, uncloneable lightmap per physical item, due in part to the inherent randomness involved in creating/depositing the phosphor layer. The system allows for other covert and overt layers for layered protection. Finally, the systems integrate easily with existing equipment (such as smartphones, industrial readers, etc.).

### Method for Manufacturing an Authenticated/Authenticable Item

A method for manufacturing an authenticated item (or an item capable of being authenticated) may provide a systematic approach for creating physical items with embedded authentication capabilities that enable secure verification without requiring external database access. The manufacturing method may integrate upconverting phosphor technology with cryptographic encoding to produce self-contained authentication systems within various types of physical items.

The method may comprise applying an upconverting phosphor layer to a target item. The application process may involve depositing upconverting phosphor particles onto a substrate surface of the target item using various manufacturing techniques. The upconverting phosphor layer application may be performed through printing processes, coating operations, or embedding techniques that integrate the phosphor particles into the target item structure. The target item may comprise cards, banknotes, clothing hangtags, product labels, or other physical items that require authentication capabilities.

The upconverting phosphor layer application may involve preparing a phosphor-containing composition that includes upconverting phosphor particles dispersed in a carrier medium. The carrier medium may comprise polymeric binders, solvents, or other materials that facilitate the application process while maintaining the optical properties of the phosphor particles. The phosphor-containing composition may be applied to the target item through screen printing, inkjet printing, flexographic printing, or other printing techniques that provide controlled deposition of the phosphor layer.

The application process may involve controlling the spatial distribution of the upconverting phosphor particles to create unique patterns or random arrangements within the phosphor layer. The spatial distribution may be achieved through controlled printing parameters, selective masking techniques, or post-application processing steps that modify the phosphor particle locations. The resulting phosphor layer may exhibit a unique spatial arrangement of phosphor particles that serves as a physical unclonable function for authentication purposes.

The method may comprise exciting the upconverting phosphor layer to generate a lightmap during the manufacturing process. The excitation operation may involve illuminating the applied phosphor layer with near-infrared radiation to activate the upconverting phosphors and produce visible light emissions. The excitation may be performed using laser sources, LED arrays, or other near-infrared light sources that provide appropriate wavelengths and power levels for phosphor activation.

The lightmap generation may occur under controlled manufacturing conditions that ensure consistent and reproducible phosphor excitation. The manufacturing environment may include controlled lighting conditions, temperature regulation, and positioning systems that maintain consistent excitation parameters across multiple target items. The controlled conditions may ensure that the generated lightmap accurately represents the phosphor distribution pattern and provides reliable reference data for subsequent authentication operations.

The excitation process may involve capturing optical emissions from the activated phosphor layer using imaging systems or optical sensors integrated into the manufacturing equipment. The imaging systems may record the spatial distribution of phosphor emissions across the phosphor layer area, creating digital representations of the lightmap pattern. The captured lightmap data may be processed immediately during manufacturing or may be stored for subsequent analysis and encoding operations.

The method may comprise dividing the lightmap into sectors and counting emitting points within each sector to produce a numerical sequence S. The sector division process may involve computational analysis of the captured lightmap image to partition the emission area into discrete spatial regions. The sectors may be defined using geometric patterns such as rectangular grids, circular regions, or other systematic arrangements that provide comprehensive coverage of the lightmap area.

The sector division may be performed using automated image processing algorithms that analyze the lightmap boundaries and determine appropriate sector configurations. The algorithms may account for the size and shape of the lightmap region, the density of phosphor emissions, and the desired resolution for pattern analysis. The sector division parameters may be standardized across manufacturing batches to ensure consistency in the authentication system implementation.

The counting operation may involve analyzing each defined sector to identify and quantify the number of emitting points within the sector boundaries. The counting process may use image processing techniques such as blob detection, peak finding, or threshold-based analysis to identify discrete emission sources within each sector. The counting algorithms may account for variations in emission intensity, phosphor particle size, and clustering behavior to provide accurate quantification of the phosphor distribution.

The numerical sequence S may be formed by organizing the sector counts into a structured data format that represents the unique characteristics of the phosphor distribution pattern. The sequence may comprise an ordered array of integer values where each value corresponds to the count of emitting points detected within a specific sector. The ordering of values within the sequence may follow predetermined patterns that facilitate subsequent encryption and comparison operations.

The method may comprise encrypting S using a rotor-based algorithm to produce an encrypted sequence C. The encryption process may apply cryptographic transformations to the numerical sequence S to generate an encrypted representation that can be incorporated into the target item as a covert marking. The rotor-based algorithm may implement multiple logical rotors with variable offsets and manufacturing-specific parameters that provide secure encryption of the phosphor pattern data.

The rotor-based encryption may involve sequential processing of each element in the numerical sequence S through multiple transformation stages. Each logical rotor may apply substitution operations that replace input values with encrypted output values based on the current rotor configuration. The rotor positions may advance according to predetermined rules or mathematical functions that modify the encryption mapping as the algorithm processes successive elements of the input sequence.

The encryption process may incorporate manufacturing-specific parameters such as production timestamps, batch identifiers, or equipment identifiers that provide unique initialization conditions for each target item. These manufacturing parameters may serve as seed values for the rotor-based algorithm, ensuring that each target item receives a unique encryption configuration that corresponds to its specific manufacturing conditions and phosphor pattern characteristics.

The encrypted sequence C may comprise alphanumeric characters, numerical digits, or encoded symbols that represent the cryptographically transformed phosphor pattern data. The encrypted sequence format may be selected to accommodate the covert marking technology used for incorporating the encrypted data into the target item. The encryption process may include error correction coding or redundancy mechanisms that enhance the reliability of the encrypted sequence under various environmental conditions or handling scenarios.

The method may comprise incorporating C as a covert marking on the target item at or near the location of the upconverting layer. The incorporation process may involve applying the encrypted sequence C to the target item using covert marking technologies that allow the encrypted data to be detected during authentication while remaining substantially invisible during normal use. The covert marking may be positioned in spatial proximity to the upconverting phosphor layer to facilitate coordinated detection during authentication operations.

The covert marking incorporation may be performed using microtext printing techniques that create extremely small text characters encoding the encrypted sequence C. The microtext printing may use specialized printing equipment capable of producing character sizes below the resolution limits of standard reproduction methods. The microtext may be applied using conventional printing inks or may use specialized inks with enhanced security properties.

The incorporation process may alternatively use UV-visible ink applications that remain invisible under ordinary lighting conditions but become visible when exposed to ultraviolet illumination. The UV-visible ink may contain fluorescent compounds that emit visible light when excited by UV radiation, allowing the encrypted sequence C to be revealed during authentication operations that include UV illumination capabilities.

The covert marking incorporation may use IR-absorptive ink applications that create contrast patterns detectable by infrared-sensitive sensors while remaining substantially invisible to human visual inspection. The IR-absorptive ink may absorb near-infrared radiation while maintaining transparency to visible light, allowing the encrypted sequence C to be detected using the same near-infrared excitation used for phosphor activation.

The incorporation process may use nano-dot patterning techniques that create extremely small dots or patterns encoding the encrypted sequence C through spatial arrangements or density variations. The nano-dot patterns may be applied using precision printing or deposition techniques that produce markings below the resolution limits of standard reproduction methods while remaining detectable using high-resolution optical sensors.

The covert marking incorporation may use laser micro-engraving processes that create physical surface modifications encoding the encrypted sequence C through variations in surface texture or reflectivity. The laser micro-engraving may produce markings with precise dimensional control and high durability, making the covert marking resistant to wear and environmental conditions while maintaining detectability through optical scanning techniques.

The method may further comprise verifying the item by using a mobile device to re-excite the UCP layer and form the lightmap. The verification process may provide quality control capabilities during manufacturing or may serve as a reference implementation for subsequent field authentication operations. The verification may involve using mobile devices equipped with near-infrared light sources and optical sensors to reproduce the authentication process under controlled manufacturing conditions.

The re-excitation process may involve activating the upconverting phosphor layer using near-infrared illumination from the mobile device to generate visible light emissions that recreate the lightmap pattern. The re-excitation may be performed under similar conditions to the original lightmap generation to ensure consistent phosphor activation and emission characteristics. The mobile device may provide controlled illumination parameters that match the excitation conditions used during the initial manufacturing process.

The verification method may comprise generating a numerical sequence S′ based on a captured image of the lightmap. The sequence generation may involve the same sector division and counting operations used during the original manufacturing process to ensure consistent digitization of the phosphor pattern. The numerical sequence S′ may be compared against the original numerical sequence S to verify the accuracy of the manufacturing process and the reliability of the authentication system implementation.

The verification method may comprise reading the covert marking from the captured image using optical detection techniques appropriate for the specific covert marking technology used during incorporation. The reading process may involve image analysis algorithms that can detect and extract the encrypted sequence C from various forms of covert markings including microtext, UV-visible ink, IR-absorptive ink, nano-dot patterns, or laser micro-engraving.

The verification method may comprise decrypting the covert marking to form decrypted sequence D using the same rotor-based algorithm and parameters used during the encryption process. The decryption may involve applying the inverse transformations of the encryption algorithm to recover the original pattern information from the encrypted sequence C. The decryption process may use the same manufacturing-specific parameters and rotor configurations to ensure accurate recovery of the reference pattern data.

The verification method may comprise confirming authenticity when decrypted sequence D≈numerical sequence S′. This mathematical relationship may define the verification criterion where approximate equality between the decrypted reference data and the captured pattern data indicates successful authentication. The approximate equality may account for measurement variations, environmental conditions, or other factors that may introduce small differences between the sequences while maintaining the overall pattern correspondence.

The authenticity confirmation may involve calculating difference metrics between the decrypted sequence D and the numerical sequence S′ to quantify the similarity between the reference and captured data. The difference metrics may be compared against predetermined tolerance thresholds that establish acceptable limits for variations while maintaining authentication security. The verification process may confirm authenticity when the difference metrics fall within the established tolerance ranges, indicating that the captured pattern corresponds to the encrypted reference data within acceptable measurement uncertainties.

A number of implementations have been described. Nevertheless, it will be understood that various modifications may be made without departing from the spirit and scope of the disclosure. Accordingly, other implementations are within the scope of the following claims.

1. A system for authenticating a physical item comprising:
an upconverting phosphor (UCP) layer disposed on the physical item and configured to emit visible light upon near-infrared excitation;
a covert marking printed on the physical item representing an encrypted code derived from a pattern of emission points of the UCP layer;
a mobile device comprising: a near-infrared vertical-cavity surface-emitting laser (VCSEL), an optical sensor, and one or more processing units, the one or more processing units configured to, collectively:
(i) cause the VCSEL to emit light to excite the UCP layer, the excitation of the UCP layer emitting light that forms a lightmap;
(ii) capture at least one image of the physical item, where each image contains the covert marking, the lightmap, or both;
(iii) digitize counts of the emission points falling within each of a plurality of defined sectors of the image of the lightmap to form a numerical sequence S′;
(iv) read the encrypted code from the covert marking;
(iv) decrypt the encrypted code using a rotor-based algorithm to produce a decrypted sequence D; and
(v) compare numerical sequence S′ to decrypted sequence D to determine authenticity.

2. The system of claim 1, wherein the rotor-based encryption algorithm comprises multiple logical rotors having independently variable offsets and a manufacturing seed key.

3. The system of claim 1, wherein the covert marking comprises microtext printing, UV-visible ink, IR-absorptive ink, nano-dot patterning, laser micro-engraving, or a combination thereof.

4. The system of claim 1, wherein authentication is confirmed when a difference metric between numerical sequence S′ and decrypted sequence D is within a predefined statistical tolerance.

5. The system of claim 1, wherein the mobile device is configured to provide a visible verification indicator or match score on the device display.

6. The system of claim 1, wherein the UCP layer contains phosphors having distinct decay-time and/or spectral signatures, and wherein the mobile device forms part of the numerical sequence S′ based on the distinct decay-time and/or spectral signatures.

7. The system of claim 1, wherein the encryption and decryption algorithms are implemented within a dedicated mobile application stored on the device.

8. The system of claim 1, wherein the system is free of an active network connection.

9. The system of claim 1, wherein the system is free of a remote database.

10. The system of claim 1, wherein the mobile device is operably coupled to a remote database.

11. The system of claim 10, wherein one or more processing units are further configured to compare a lightmap generated from the at least one image to a lightmap stored on the remote database.

12. The system of claim 10, wherein one or more processing units are further configured to compare a lightmap generated from the at least one image to a lightmap stored on the remote database.

13. The system of claim 1, wherein the physical item is a card, banknote, a clothing hangtag, or a product label.

14. The system of claim 1, wherein the emission points in the UCP layer consist of a plurality of types of phosphors.

15. The system of claim 1, wherein the physical item further comprises a radiation blocking layer operably coupled to a base substrate upon which the UCP layer is disposed and/or a transparent window through the base substrate.

16. The system of claim 1, wherein at least some of the defined sectors overlap.

17. The system of claim 1, wherein the defined sectors are free of overlap.

18. The system of claim 1, wherein the all emission points are within the defined sectors.

19. A method for manufacturing an authenticated item, comprising:
applying an upconverting phosphor layer to a target item;
exciting the upconverting phosphor layer to generate a lightmap;
dividing the lightmap into sectors and counting emitting points within each sector to produce a numerical sequence S;
encrypting S using a rotor-based algorithm to produce an encrypted sequence C; and
incorporating C as a covert marking on the target item at or near the location of the upconverting layer.

20. The method of claim 9, further comprising verifying the item by:
using a mobile device to re-excite the UCP layer and form the lightmap;
generating a numerical sequence S′ based on the lightmap captured on at least one image, each at least one image containing the covert marking, the lightmap, or both;
reading the covert marking from the at least one image;
decrypting the covert marking to form decrypted sequence D; and
confirming authenticity when decrypted sequence D≈numerical sequence S′.
